(19) United States
(12) Patent Application Publication
(10) Pub. No.: US 2003/0213181 A1
(43) Pub. Date: Nov. 20, 2003

(54) Surface treated gaskets and gasket-like devices and methods of manufacturing and treating same

(75) Inventor: Thomas L. Weil, Elverson, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Davlyn Manufacturing Company, Inc.

(21) Appl. No.: 10/150,665

(22) Filed: May 17, 2002

(51) Int. Cl. E06B 7/16

(52) U.S. Cl. 49/492.1

(57) ABSTRACT

A gasket-like device includes an elongated core, an outer jacket of glass fiber yarns, woven, preferably braided, entirely around and along the core. Each of the glass fiber yarns has an outer surface exposed to view with a polymeric resin coating in an amount sufficient to at least cover essentially all of an outer surface of each yarn exposed on the device and insufficient to obscure the plurality of individual glass fiber yarns from one another in the outer jacket. The outer covering may be coated with a colored polymeric resin to produce a desired exterior color. In a described embodiment for self-cleaning ovens, a plurality of individual fasteners are spaced along the device. Each fastener includes a base captured within the outer jacket and an engagement portion extending outwardly from the base through the outer jacket. A method of manufacturing and coloring the gasket-like device is also disclosed.

### CROSS-REFERENCE TO RELATED APPLICATIONS

The invention relates to gaskets and gasket-like devices such as weather-strips, molding and the like and, in particular, to such devices having integral fasteners for attaching the device to a support, as well as methods of manufacturing and surface treating such devices.

### BACKGROUND OF THE INVENTION

The doors of many appliances such as refrigerators, ranges, microwave ovens, etc. typically have a flexible, tubular gasket around their perimeter for sealing and a variety of other reasons. Previously, such doors have been fabricated by joining together front and back pieces. This has enabled the door manufacturers to use gasket assemblies which include a pair of joined, parallel, elongated cylindrical members. One member was then either pushed through a slot or slots provided on the “back” piece of the door or wound around the perimeter of such a back piece which was then fitted into a receiving cavity in the “front” piece of the door. An exposed cylindrical member formed the gasket while a remaining cylindrical member, hidden within the door, held the gasket cylindrical member in place against the door.

One approach for mechanically mounting such gaskets to one-piece doors oven has been disclosed in U.S. Pat. No. 4,822,060 to Moyer et al., incorporated by reference herein. That patent discloses providing a flexible, hollow cylindrical gasket with clip-type fasteners protruding along one side thereof. Such gaskets are formed from a hollow, tubular, knitted wire core and braided, glass fiber outer jacket, somewhat similar to the cylindrical members of the old gasket assemblies. A single wire member is bent at several locations along its length to form a series of connected clip members.

Other clip equipped gasket constructions and fabricating methods are disclosed in U.S. Pat. Nos. 5,107,623 and 4,986,033, incorporated by reference herein. These patents disclose an improved elongated gasket-like device. The device comprises an elongated core, a woven outer jacket surrounding the core and extending along the core, and a plurality of separate, individual fasteners spaced along the device and captured between the core and the woven outer jacket. Each fastener has a base end and an engagement portion, with the base being irremovably retained in the device by portions of the core and the woven outer jacket adjoining one another and each fastener engagement portion extending through the adjoining portion of the woven outer jacket, each fastener has an engagement portion protruding outwardly from the adjoining portion of the woven outer jacket. The individual fasteners are connected to one another within the outer jacket only through being captured by the core and the woven outer jacket.

In one variation, an outer covering is provided over the entire outer jacket, for example by dipping or extrusion, to provide another outermost material layer to the device. As indicated in the figures, this layer is integrally circumferential in that it extends continuously and unbrokenly along the surface of the woven outer jacket covering. It is also sufficiently thick to essentially obscure the woven structure of the jacket with its own smooth, continuous structure. The only outer covering disclosed (silicone rubber) can provide useful characteristics, most notably moisture and/or air barriers. However, silicone rubber is not suited for certain uses such as on devices used as gaskets for the doors of self-cleaning electric ovens, where the device can be exposed to operating temperatures of 500° F. or more, temperatures at which this elastomer embrittles and deteriorates.

It is believed it would be desirable to appliance manufacturers and other end users of these devices, if the devices could be provided with certain improved characteristics while still retaining the relatively high temperature operating characteristics of the basic device, which is formed by metal clips, a knitted wire inner tube and the braided glass fiber outer jacket. For example, it is believed that the ability to offer these devices in different colors or with more consistent coloring would be desirable to appliance manufacturers for greater customer desire and acceptance of the appliances. Also, such colored glass fiber-jacketed devices are likely to find other appearance-enhancing uses, with or without metal clips.

### BRIEF SUMMARY OF THE INVENTION

Briefly, the invention, is an elongated gasket-like device comprising an elongated core; an outer jacket surrounding the core and extending along the core woven from a plurality of individual glass fiber yarns, each of the yarns including a permanent polymeric resin emulsion solid residue outer coating. The coating is attached to the glass fiber sufficiently to resist ruboff with ordinary handling. The solid residue outer coating is applied in an amount sufficient to cover at least essentially all of an outer surface of each yarn exposed on the device and insufficient to obscure the plurality of individual glass fiber yarns from one another in the outer jacket.

The invention is also a method of making the elongated gasket-like device recited above with spaced fasteners comprising the steps of: providing an assembled device including the elongated core and the woven outer jacket; and immersing the assembled device in a polymeric resin emulsion sufficiently so as to at least substantially individually coat with a coating of the emulsion at least an outer surface of each of the glass fiber yarns exposed on the woven outer jacket; and removing a liquid portion of the emulsion from the device to leave the permanent polymeric resin emulsion solid residue affixed to the yarns.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a perspective, diagrammatic, partially-sectioned view of a preferred embodiment of a gasket-like device of the invention;

FIG. 1a is a greatly enlarged transverse cross-sectional view of a coated yarn of the woven outer jacket of the device of FIG. 1:

FIG. 2 is a diagrammatic, transverse, local cross-sectional view of the device of FIG. 1 along the lines 2-2;

FIG. 3 is a diagrammatic, longitudinal, local cross-sectional view of the device of FIGS. 1 and 2 along the lines 3-3;

FIG. 4 is a diagrammatic, perspective view of a first clip;

FIG. 5 is a diagrammatic view of a braiding machine configured to fabricate the devices of the subject invention in the preferred mode;

FIG. 6 is a diagrammatic, perspective, partially-sectioned view of a generally planar embodiment of the invention;

FIG. 7 is a transverse, cross-sectional view of the embodiment of FIG. 6 along the lines 7-7;

FIG. 8 is a perspective view of a presently preferred bent wire spring clip-type fastener;

FIG. 9 is a cross-section of a single yarn of the woven outer jacket of the device with a resin outer coating.

### DETAILED DESCRIPTION OF THE INVENTION

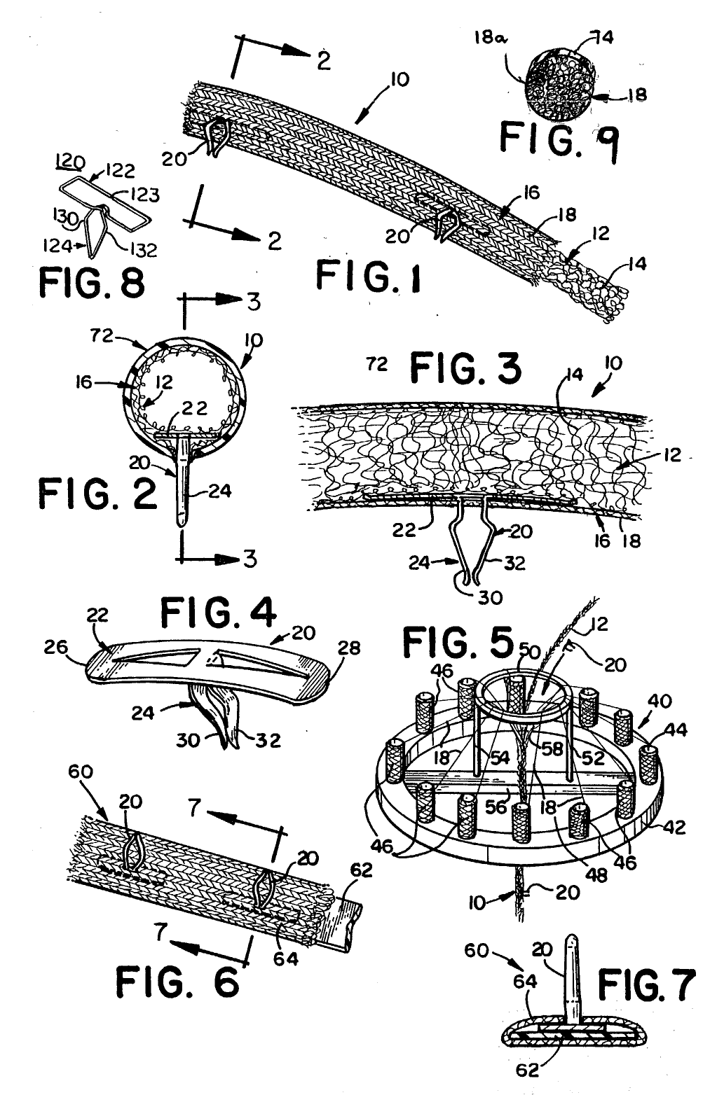

Referring to the drawings, wherein like numerals are employed for the indication of like elements throughout, there is shown in FIGS. 1-3, a first preferred embodiment gasket-like device 10 of the invention. Referring to FIG. 1, the basic, essential components of the device 10 include an elongated core 12, a surrounding woven outer jacket 16 and a plurality of separate, individual fasteners 20. The core 12 is preferably a continuous, flexible, cylindrically-shaped, tubular member preferably knitted from a plurality of stainless steel wires 14 in a conventional fashion. The core 12 is shown in FIG. 1 as extending from one end of the device 10 for clarity. A woven outer jacket 16 surrounds and extends along the core 12. Preferably the jacket 16 is braided from a plurality of glass fiber yarns 18. The plurality of individual fasteners are preferably spring clip-type fasteners 20 and are preferably spaced at predetermined intervals along the device 10.

According to an important aspect of this invention, there is a coating, preferably a resin emulsion solid residue polymeric outer coating, affixed on each of the yarns 18 of the outer jacket 14. Referring to FIG. 9, the coating 74 covers at least essentially all of an outer surface 18a of each yarn 18 which is exposed on the outer jacket 14 of the device 10. The coating 74 on each yarn 18 thus extends at least partially (and in many, if not most cases, only partially) around each yarn and only where that portion of the outer surface of the yarn 18 is actually exposed forming part of the exposed outer surface of the outer jacket 14. The coating 74 further extends at least substantially and, preferably, at least essentially along the entire length of each yarn 18 and the device 10. However, it should be appreciated that the coating 74 may not extend entirely around or continuously along the entire length of each yarn because of manufacturing limitations, for example, the need or desire to support the ends of the basic device during a coating process, which prevents the supported portion(s) from being coated, or a particularly tight braid of the glass fiber yarns, which hinders the penetration of even aqueous coatings like those to be described, to surfaces of the yarns hidden within the outer jacket 14. The coating usually is intermittent along each yarn. That is, the coating is often absent from those outward facing portions of the outer surface of each yarn which are not actually exposed on the outer surface of the jacket because such outward facing portions yarns are covered by other yarns of the weave.

A first type of clip 20 is shown separately in FIG. 4. As can be seen in that figure, the clip includes a base 22 and an engagement portion 24 integral with the base 22 and extending substantially perpendicularly from one side thereof. The base 22 is substantially elongated between a pair of opposing ends 26 and 28 each of which is substantially rounded primarily to prevent cutting of the outer jacket 16. The engagement portion 24 of each clip includes a pair of adjoining, resiliently flexible spring arms 30 and 32 which can be compressed against one another to enable the arms 30, 32 pass through an opening in the member to which the device 10 is attached and then return to their original, depicted configuration, thereby securing the device to the member by an interference fit. As is best seen in FIG. 2, the base 22 of each clip 20 is captured between the core 12 and the outer jacket 16 with the engagement portion 24 extending away from the base 22 through the outer jacket 16. In particular, the base 22 of each clip 20 is irremovably retained between portions of the core 12 and woven outer jacket 16 which adjoin one another and the base 22 by the adjoining portions of the core 12 and woven outer jacket 16. Thus, the base 22 of each clip 20 cannot be passed, for example through the core 12 into the hollow interior of the device 10 or through the outer jacket 16 without partially severing or otherwise removing or damaging at least one of the adjoining portion of the core 12 or jacket 16. Engagement portion 24 extends away from the base and the portion of the core 12 adjoining the base and protrudes outwardly from the woven outer jacket through the portion of the outer jacket 16 adjoining the core 12 and base 22. The basic device 10 formed by the core 12, woven outer jacket 16 and clip-type fasteners 20 can be used as a gasket in a conventional oven door, including the doors of self-cleaning electric ovens.

The depicted clips 20 may be formed by stamping from a planar sheet of metal. However, other type clips and other fasteners of a wide variety of constructions and materials including plastic, composite plastic and metal, etc. can be used if suitable for the use to which the device is made. Moreover, since a variety of clips or other types of fasteners can be employed, the configuration of the engagement portion 24 and base 22 can be varied and the engagement force developed by the engagement portion 24 selected from a potentially wide range of attachment forces which can be achieved. The base 22 might be slightly longitudinally cambered as indicated to maintain the engagement portion 24 under tension when installed, thereby preventing movement between the clip 20 and the member receiving the clip 20. The base 22 also can be cambered transversely or otherwise shaped in any desired way to optimize seating of the fastener against the receiving door or other member.

FIG. 8 depicts diagrammatically a presently preferred, separate, individual fastener in the form of a bent wire, spring clip-type fastener, indicated generally at 120. Preferably, the clip 120 is formed from a single length of wire having a rounded, preferably circular cross-section. Preferably, the wire is bent so as to form a generally diamond-shaped engagement portion, indicated at 124, protruding generally perpendicularly from a generally rectangular base portion, indicated at 122. The wire is bent along radii to form corners of the base so that the opposing longitudinal ends of the base 122 are still substantially rounded sufficiently to prevent cutting of the woven outer jacket by the base. Preferably, engagement portion 124 is formed by a central portion of the length of the wire while the base portion 122 is formed by the remaining opposing ends of the length of wire on either side of the central portion. Ends of the wire come together in the base 122 at point 123. These ends are preferably left unattached to one another so as to be able to separate when “arms” 130 and 132 of the engagement portion 124 are squeezed together. The base is nominally about one inch long by 0.25 inch wide. The engagement portion 24 is nominally about one-half inch high and approximately 3/16 inch wide at the widest point, which is about ⅛ inch from the base 122.

The preferred material of clip 120 is Type 304 stainless steel wire, preferably diamond drawn, about 0.025 inch in diameter, and at least half hard and less than full hard, in particular, having a tensile strength greater than at least about 156,000 psi and less than about 300,000 psi, preferably between about 200,000 and 240,000 psi. The smooth finish provided by diamond drawing also seems to assist in fabricating the devices of the present invention by permitting the engagement portion 124 of clip 120 to slip more easily through the yarn forming the outer jacket 16.

Fabrication of the basic device 10 is as follows. The preferred, knitted wire core 12 is conventional, and its manufacture is known to those of ordinary skill in this art. Also, it is described at least to some extent in U.S. Pat. No. 3,578,764, incorporated herein by reference in its entirety. That patent discloses the beneficial uses of a heat-resistant, flexible knitted metal wire core and a flexible, heat-resistant fabric jacket or cover of glass fiber yarns for use as an oven door gasket. Conventional elongated, tubular knitted wire members can be obtained from such distributors as Montgomery Co., Windsor Locks, Conn. and ACS Industries, Woonsocket, R.I. A flexible knitted wire core 12 for an oven door gasket might be made of 7 mil, full hard 304 stainless steel wire in a continuous jersey knit having 12 wales and 13±1 courses/inch to form a continuous knit, cylindrically-shaped, hollow tube approximately ½ inch in diameter. The specification for a wire knitting machine to knit a hollow wire core like the core 12 would be ⅞ inch cylinder, 12 needles, 18 gauge, circular jersey knitting machine.

The method of providing the woven outer jacket 16 capturing the base 22 or 122 of the clip fasteners 20 or 120 against the core 12 is also straightforward. FIG. 5 depicts diagrammatically significant portions of a conventional braiding machine 40 which includes a base 42 mounting a multiplicity of spindles 44. Each spindle 44 receives a separate bobbin 46 of yarn 18. Only a few of the spindles 44 and bobbins 46 are depicted for clarity. The spindles 44 and bobbins 46 are driven along tracks (not depicted) in the base 42 in a weaving, maypole fashion so as to braid a continuous tubular outer jacket 16 around the core 12.

Such braiding machines can be obtained from a variety of commercial sources including Wardwell Braiding Machine Company, Central Falls, R.I. and Braider Manufacturing Company-Kokubun, Inc., Nakajimacho, Hanamatsu, Japan. The typical specification for such a machine is a 72 carrier braider, No. 2 butt, 36×100 gear ratio with 24 inch capstan. The typical specification for such a braided jacket might be, for example, 72 ends of yarn (fiberglass) size-150's, 10 count, 20±1 picks per inch.

The core 12 of the device 10 is fed through the center opening 48 in the base 42. The machine 40 thereupon braids the yarns 18 into the outer jacket 16 extending around and along the length of the core 12. Normally in such machines, the core 12 would be fed upward and the fasteners inserted upwardly between the ascending core 12 and a cone formed by the multiplicity of yarns 18 being laid over that core 12 until some portion of the base 22 of the clip fastener 20 is captured by the yarns 18 and held against the core 12.

To assist in positioning the clips 20 or other fasteners, the braider 40 may be modified in a known manner depicted diagrammatically in FIG. 5 to add a central reversing ring 50 which enables the core 12 to be fed vertically downward, rather than upward, through the machine 40. The ring 50 is supported by a pair of arms 52 and 54 attached to a cross piece 56 fixedly supported in the central opening 48 of the base 42. In this way, a funnel 58, which is defined by the yarns 18 converging on the core 12, tapers downwardly onto the core 12, permitting the clips 20 or other individual fasteners to be inserted downwardly among the converging yarns 18 from above, as depicted. This simplifies, to some extent, the feeding and positioning of the individual fasteners.

Preferably, the clips 20 or 120 or other individual fasteners are inserted automatically by a suitably configured inserting mechanism. The mechanism might include, for example, a vibratory bowl having a vibrating reservoir at one end for orienting and feeding the clips 20 or 120 to the mouth of a stationary chute. The chute can extend from the vibrating reservoir towards the reversing ring of the braider and terminate at a point close to where the braided funnel 58 of glass fiber yarns contacts the core 12. An escapement, for example, may be provided to release one clip at a time down the chute. The clip is held at the lower end of the chute with the base portion of the clip contacting or nearly contacting the core and the engagement portion of the clip nearly contacting the individual yarns tapering together in the funnel 58. The clip at the end of the chute can thereafter be pushed between the converging core and yarns 18 forming the descending funnel 58 by suitable means, such as a solenoid-operated plunger which is timed for operation of the braider and/or the core feeder.

FIGS. 6 and 7 depict another preferred embodiment of the invention in the form of a generally flat, elongated, continuous, gasket-like device 60 with a multiplicity of clip fasteners 20 protruding from one side thereof. The device 60 includes, in addition to the clips 20, a substantially planar, elongated core 62 and a surrounding planar woven outer jacket 64. The jacket 64 can be braided using a conventional braiding machine, like those previously identified, with salvage bars as are conventionally used on such machines to provide a substantially planar braided jacket 64 around the planar core 62. The planar core 62 could be formed by flattening a tubular knitted wire core like core 12 of the device 10. Other flexible, planar elongated members of fabric, plastic, metal or the like alternatively could be used.

After braiding (and the insertion of any wire clips), the glass fiber outer jacket 16 of the device 10 can be heat treated, if desired, in a conventional fashion for coloration. However, the present invention includes a new method of surface treatment for coloring and other purposes. More particularly, the individual yarns 18 of outer jacket 14 can be individually coated, preferably with a polymeric material in the form of a silicone resin coating 74, to provide a desired color or other surface treatment to the outer jacket 14. The silicone resin coating 74 is preferably one which resists temperatures up to at least 800° F. (about 427° C.), without color change or other adverse deterioration including loss of adhesion, for use with self cleaning electric ovens. One suggested coating is Dow Corning® 1-0469 waterborne resin, which is an anionic emulsion of a medium-hard phenylmethyl silicone resin. Alternatively, Dow Corning® 1-0468 waterborne resin, which is an anionic emulsion of a soft phenylmethyl silicone resin and which resists temperatures to about 1,200° F. (560° C.), can be used where higher temperature resistance is required or desired. The particle size of the resins in these emulsions is less than 700 nanometers.

Preferably, the silicone resin coating 74 is applied as a water based emulsion containing resin solids. The emulsion is formed using conventional equipment normally used for preparing latex coatings and paints. The emulsions identified above are supplied at a concentration of about sixty percent by weight of resin solids. It is suggested that this concentration be reduces to about five percent or less of resin solids by the addition of water. A one quart of supplied emulsion (sixty percent solids) is suggestedly added to five gallons of water to provide about a three percent by weight concentration of resin solids in the emulsion. This not only reduces initial material costs, it further reduces the loss due to bum-off, which typically occurs when the resin solids are heated above 300° F. To adhere the resin to the device 10, the device 10 is coated with the silicone resin emulsion, preferably by being immersed in the silicone resin emulsion. If the device 10 is fabricated in continuous lengths, the lengths can be continuously passed through a trough or other appropriate reservoir to coat the outer jacket. After removal, the liquid portion of the emulsion on the outer jacket is driven off, suggestedly by drying at a maximum temperature below that at which bum off occurs, typically less than about 300° F., and then heat curing at a minimum temperature at which at least partial bum off does occur, typically above 300° F. Bum off is characterized by smoke being generated. It is further believed at these temperatures that at least some of the silicone resin is converted to silicon, which bonds to the glass. More specifically, the coating 74 is suggestedly first dried at room temperature to the point where the coating does not rub off by ordinary handling. It then is heat cured for approximately thirty minutes or more at approximately 450° F. (232° C.) to achieve at least partial burn off. Where being installed in self-cleaning ovens, the curing step can be performed by the ultimate purchaser when first using the oven in the self-cleaning mode. The cured silicone resin provides a permanent solid coating 74 affixed to the yarns 18 forming the outer layer 72. The coating 74 is provided in this way in an amount which is insufficient to obscure the individual yarns of the outer jacket 14 from one another, thus allowing the observer to still discern the individual fibers in the braid or other weave used. The coating 74 is also flexible to flex with the device 10 during use as an oven gasket.

Gray to black color can easily be added to the coating 74 by the addition of graphite in varying concentrations to the diluted emulsion. For example for the quart of resin concentrate in five gallons of water, sixty grams of added graphite solids will impart a light gray to silvery color to the coating and the outer jacket 14. Suggestedly, a colloidal graphite suspended in water can be used. The addition of six hundred grams graphite (solids) imparts a very dark gray to black color to the coating 74 and outer jacket 14. Different shades of gray in between can be achieved by different intermediate concentrations of graphite. Other pigments can be used to provide other colors in varying shades. Those skilled in the art will recognize that the device 60 and other woven glass fiber jacketed devices can be colored in the same manner as described above with regard to the device 10.

The use of the disclosed devices 10 and 60 would be in a conventional fashion by inserting the clips 20 (or 120) or other provided fasteners into holes, mating members or other suitable receptacle in a door or other receiving structure.

The devices of the subject invention enjoy considerable advantages over existing gaskets and gasket-like devices formed by the insertion of a bent, continuous wire through the various layers forming the device to provide fasteners. In particular, the devices of the subject invention can be made using solid as well as hollow cores, as is illustrated by the embodiment of FIGS. 6 and 7. It will be appreciated that devices of the subject invention can be provided in a wide variety of sizes. While knitted wire is preferred as the core material for strength, flexibility, light weight and temperature resistance, other type of hollow and solid cores and core materials can be used.

While various embodiments of the invention have been disclosed, and modifications thereto suggested it will be recognized by those skilled in the art that changes could be made to the above-described embodiments without departing from the broad, inventive concept thereof. It is understood, therefore, that this invention is not limited to the particular embodiments disclosed, but is intended to cover any modifications which are within the scope and spirit of the invention, as defined by the appended claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. An elongated, gasket-like device comprising:
an elongated core; and
an outer jacket surrounding the core and extending along the core woven from a plurality of individual glass fiber yarns, each of the yarns including a polymeric resin emulsion solid residue outer coating attached to the glass fiber sufficiently to resist ruboff with ordinary handling and applied in an amount sufficient to at least cover essentially all of an outer surface of each yarn exposed on the device and insufficient to obscure the plurality of individual glass fiber yarns from one another in the outer jacket.

2. The device of claim 1 further comprising:
a plurality of fasteners spaced along the device and captured within the woven outer jacket, each fastener having a base end and an engagement portion extending away from the base and through the woven outer jacket.

3. The device of claim 1 wherein the outer coating comprises a silicone resin.

4. The device of claim 3 wherein the outer coating further comprises a pigment having a color different from the resin.

5. The device of claim 4 wherein the pigment comprises graphite.

6. The device of claim 5 wherein the pigment consists essentially of graphite.

7. The device of claim 6 wherein the silicone resin comprises a soft to medium hard phenylmethyl silicon resin.

8. The device of claim 1 wherein the outer coating comprises a soft to medium-hard phenylmethyl silicone resin.

9. A method of making the elongated gasket-like device of claim 1 with spaced fasteners comprising the steps of:
providing an assembled device including the elongated core and the woven outer jacket;
immersing the assembled device in a polymeric resin emulsion sufficiently so as to at least substantially individually coat with a coating of the emulsion at least an exposed outer surface of each of the glass fiber yarns of the woven outer jacket; and
removing a liquid portion of the emulsion from the device to leave the polymeric resin emulsion solid residue affixed to the yarns.

10. The method according to claim 9, wherein the emulsion comprises a silicone resin.

11. The method according to claim 9, wherein the polymeric resin emulsion comprises a soft to medium-hard phenylmethyl resin.

12. The method according to claim 9, wherein the emulsion includes up to five percent by weight resin solids.

13. The method according to claim 9, wherein the emulsion further includes a color pigment having a color different from the resin.

14. The method according to claim 13 wherein the pigment comprises of graphite.

15. The method according to claim 14 wherein the pigment consists essentially of graphite.

16. The method of claim 9 wherein the removing step comprises drying the device with the emulsion coating to a maximum temperature of less than 300° F.

17. The method according to claim 16 wherein the removing step comprises heating the device with the emulsion coating after the drying step to a minimum temperature above 300° F.

18. The method according to claim 9 wherein the removing step comprises heating the device with the emulsion coating after the drying step to a minimum temperature above 300° F.
